(19) United States
(12) Patent Application Publication
(10) Pub. No.: US 2024/0046523 A1
(43) Pub. Date: Feb. 8, 2024

(54) Mesh Processing Method, Device, Electronic Apparatus and Computer Readable Storage Medium

(71) Applicant: Zhuhai Prometheus Vision Technology Co., LTD, Zhuhai (CN)

(72) Inventors: Yu ZHANG, Zhuhai (CN); Hongyi LI, Zhuhai (CN); Zhijing SHAO, Zhuhai (CN); Wei SUN, Zhuhai (CN)

(21) Appl. No.: 18/093,370

(22) Filed: Jan. 5, 2023

(30) Foreign Application Priority Data
Aug. 5, 2022 (CN) 202210938831.8

(51) Int. Cl. G06T 9/00; G06T 17/20

(52) U.S. Cl. CPC G06T 9/001; G06T 17/205

(57) ABSTRACT

Embodiments of the present disclosure are directed to a mesh processing method, device, electronic apparatus and computer readable storage medium. The mesh processing method includes: randomly selecting at least two triangular patches from a plurality of triangular patches of a triangular mesh as reference triangular patches, dividing the triangular mesh into a plurality of sub-triangular meshes according to a spatial position of each of the reference triangular patches in the triangular mesh, and for each of the sub-triangular meshes, taking the reference triangular patch corresponding to the sub-triangular mesh as a traversal starting point and traversing the remaining triangular patches in the sub-triangular mesh.

### CROSS REFERENCE TO RELATED APPLICATION

This application claims the priority of Chinese Patent Application No. 202210938831.8, entitled “Mesh Processing Method, Device, Electronic Apparatus and Computer Readable Storage Medium”, filed on Aug. 5, 2022, the disclosure of which is incorporated herein by reference in its entirety.

### FIELD OF INVENTION

The embodiments of the present disclosure relate to the technical field of computers, and relate to a mesh processing method, device, electronic apparatus, and computer-readable storage medium.

### BACKGROUND

Compression of a triangular mesh is a classic issue in the field of computer graphics and digital geometry processing and plays an important role in applications such as large-scale 3D model storage and network-based 3D graphics.

A triangular mesh model requires two general types of information to be stored: topological information and geometric information. Correspondingly, there are topological compression and geometric compression, wherein, the geometric compression is carried out on the basis of the strategy of the topological compression. Therefore, the compression efficiency of the topological compression also affects the efficiency of the geometric compression, which affects the overall compression efficiency of the triangular mesh.

The topological compression depends on the traversal speed of triangular patches in the triangular mesh. Currently, in the process of the topological compression, the traversal speed of triangular patches can be further improved.

### SUMMARY

Embodiments of the present disclosure are directed to a mesh processing method, a device, an electronic apparatus, and a computer-readable storage device, improving a traversal speed of triangular patches.

In the first aspect, an embodiment of the present disclosure a mesh processing method comprises:
randomly selecting at least two triangular patches from a plurality of triangular patches of a triangular mesh as reference triangular patches;
dividing the triangular mesh into a plurality of sub-triangular meshes according to a spatial position of each of the reference triangular patches in the triangular mesh;
for each of the sub-triangular meshes, taking the reference triangular patch corresponding to the sub-triangular mesh as a traversal starting point and traversing the remaining triangular patches in the sub-triangular mesh.

In the second aspect, an embodiment of the present disclosure provides a mesh processing device comprising:
a selection module, configured to randomly select at least two triangular patches from a plurality of triangular patches of a triangular mesh as reference triangular patches;
a dividing module, configured to divide the triangular mesh into a plurality of sub-triangular meshes according to the spatial position of each of the reference triangular patches in the triangular mesh;
a traversal module, configured to, for each of the sub-triangular meshes, take the reference triangular patch corresponding to the sub-triangular mesh as a traversal starting point and traverse the remaining triangular patches in the sub-triangular mesh.

In some embodiments, the device also comprises a topological compression module. The topological compression module comprises:
an acquisition unit configured to, in the traversing process, establish an index of each of the reference triangular patches and obtain a topological relation operator corresponding to each triangular patch;
a concatenation unit configured to, for each sub-triangular mesh, concatenate multiple topological relation operators corresponding to the sub-triangular mesh according to the traversal order corresponding to the sub-triangular mesh to obtain a sub-operator string;
a splicing unit configured to, according to the index of the reference triangular patch corresponding to each of the sub-triangular meshes, splice the sub-operator strings to obtain a general operator string;
a topological compression unit configured to encode and compress the general operator string according to the appearance frequency of each topological relation operator in the general operator string to obtain a compressed general operator string.

In some embodiments, the acquisition unit comprises:
a determination subunit configured to, for each triangular patch in each of the sub-triangular meshes, determine the topological relation between the triangular patch and multiple triangular patches that are not traversed in the sub-triangular mesh;
an acquisition subunit configured to obtain the topological relation operator corresponding to the triangular patch according to the topological relation.

In some embodiments, the acquisition subunit is configured to:
obtain a mapping relation set, the mapping relation set comprising a mapping relation between a preset topological relation and a preset topological relation operator;
determine the topological relation operator corresponding to the topological relation of the triangular patch according to the mapping relation.

In some embodiments, the topological compression unit comprises a topological compression subunit that is configured to encoding and compressing the general operator string with Huffman coding to obtain the compressed general operator string.

In some embodiments, the triangular patch comprises three vertices of the triangular mesh. The device further comprises a mesh compression module, and the mesh compression module comprises:
a preliminary compression unit configured to compress the respective sub-triangular meshes at the same time according to the traversal order corresponding to the respective sub-triangular meshes and the corresponding index of each sub-triangular mesh to obtain a preliminary compressed file;
an integration unit configured to integrate the indexes and the compressed general operator string integrated into the preliminary compressed file to obtain a general compressed file corresponding to the triangular mesh.

In some embodiments, the device further comprises a decompression module, and the decompression module comprises:
a decompression unit configured to, when the general compressed file is decompressed, decompress the compressed general operator string to obtain the general operator string, and, at the same time, decompress the sub-triangular mesh corresponding to each index to obtain multiple triangular patches corresponding each of the sub-triangular meshes;
a connection unit configured to splice the triangular patches corresponding to each of the sub-triangular meshes according to the respective topological relations of the respective triangular patches described by the general operator string to obtain the triangular mesh.

In the third aspect, an embodiment of the present disclosure provides an electronics apparatus comprising a processor and a memory storing computer instructions executable by the processor to perform operations comprising: randomly selecting at least two triangular patches from a plurality of triangular patches of a triangular mesh as reference triangular patches; dividing the triangular mesh into a plurality of sub-triangular meshes according to a spatial position of each of the reference triangular patches in the triangular mesh; for each of the sub-triangular meshes, taking the reference triangular patch corresponding to the sub-triangular mesh as a traversal starting point and traversing the remaining triangular patches in the sub-triangular mesh.

In the fourth aspect, an embodiment of the present disclosure provides a non-transitory computer readable storage medium storing computer instructions executable by a processor to perform operations comprising: randomly selecting at least two triangular patches from a plurality of triangular patches of a triangular mesh as reference triangular patches; dividing the triangular mesh into a plurality of sub-triangular meshes according to a spatial position of each of the reference triangular patches in the triangular mesh; for each of the sub-triangular meshes, taking the reference triangular patch corresponding to the sub-triangular mesh as a traversal starting point and traversing the remaining triangular patches in the sub-triangular mesh.

The embodiments of the present disclosure randomly select at least two triangular patches from a plurality of triangular patches of a triangular mesh as reference triangular patches, divides the triangular mesh into a plurality of sub-triangular meshes according to a spatial position of each of the reference triangular patches in the triangular mesh, and for each of the sub-triangular meshes, take the reference triangular patch corresponding to the sub-triangular mesh as a traversal starting point and traversing the remaining triangular patches in the sub-triangular mesh. Compared to the related technology that selects a single triangular patch to be traversed from a triangular mesh, the traversal speed of the triangular patches can be enhanced by selecting multiple triangular patches, taking the respective reference triangular patches as traversal starting points, and traversing the triangular patches in the triangular mesh at the same time. The remaining triangular patches in each sub-triangular mesh can be traversing at the same time by dividing the triangular mesh into the sub-triangular meshes according to the spatial position of each of the reference triangular patches in the triangular mesh, which avoids the traversal repetition during a plurality of traversing processes and ensures the orderly execution of the respective traversing processes.

### BRIEF DESCRIPTION OF DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a scene schematic diagram of a mesh processing method of an embodiment of the present disclosure.

FIG. 2 is flow chart of a mesh processing method of an embodiment of the present disclosure.

FIG. 3 is a schematic diagram showing a topology relationship between triangular patches of an embodiment of the present disclosure.

FIG. 4 is a schematic diagram showing a mesh processing device of an embodiment of the present disclosure.

FIG. 5 is a schematic diagram showing an electronic apparatus of an embodiment of the present disclosure.

### DETAILED DESCRIPTION OF EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

The embodiments of the present disclosure provide a mesh processing method, device, electronic apparatus, and computer-readable storage medium. The embodiments of the present disclosure provide the mesh processing device adapted in the electronic apparatus. The electronic apparatus comprises a terminal device or server. The terminal device may comprise a computer, a tablet, or a cell phone. The server may be an independent physical server, or a server cluster or distributed system composed of a plurality of physical servers, or a cloud server based on cloud computing service for providing cloud services, cloud databases, cloud computing, cloud functions, cloud storage, network services, cloud communications, middleware services, domain name services, security services, content distribution networks (CDN, content Delivery Networks), and data and artificial intelligence platforms. The server can be directly or indirectly connected by wired or wireless communication.

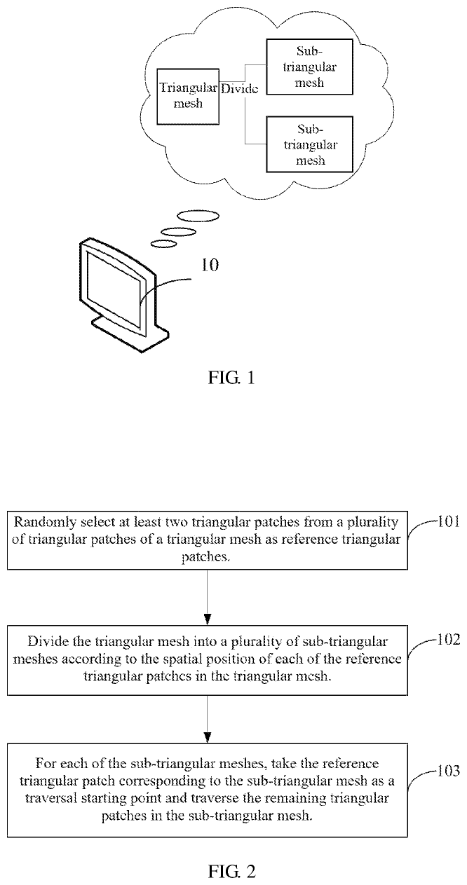

The mesh processing method in the embodiment of the present disclosure can be executed solely by the terminal device, or solely by the server, or by the terminal device and the server jointly. Please refer to FIG. 1. Taking the terminal device 10 solely executing the meth processing method as an example, the terminal device 10 obtains a triangular mesh according to a reconstructed model of a three-dimensional subject, randomly select at least two triangular patches from a plurality of triangular patches of the three-dimensional mesh as reference triangular patches. According to the spatial positions of the reference triangular patches in the triangular mesh, the triangular mesh is divided into a plurality of sub-triangular meshes. For each of the sub-triangular meshes, the reference triangular patch corresponding to the sub-triangular mesh is taken as a traversal starting point, and the remaining triangular patches in the sub-triangular mesh are traversed.

Embodiments of the present disclosure randomly select at least two triangular patches from a plurality of triangular patches of a triangular mesh as reference triangular patches, divides the triangular mesh into a plurality of sub-triangular meshes according to a spatial position of each of the reference triangular patches in the triangular mesh, and for each of the sub-triangular meshes, take the reference triangular patch corresponding to the sub-triangular mesh as a traversal starting point and traversing the remaining triangular patches in the sub-triangular mesh. Compared to the related technology that selects a single triangular patch to be traversed from a triangular mesh, the traversal speed of the triangular patches can be enhanced by selecting multiple triangular patches, taking the respective reference triangular patches as traversal starting points, and traversing the triangular patches in the triangular mesh at the same time. The remaining triangular patches in each sub-triangular mesh can be traversing at the same time by dividing the triangular mesh into the sub-triangular meshes according to the spatial position of each of the reference triangular patches in the triangular mesh, which avoids the traversal repetition during a plurality of traversing processes and ensures the orderly execution of the respective traversing processes.

Each will be described in detail below. It should be noted that the order of description of the following embodiments is not intended to limit the order of priority of the embodiments.

Please refer to FIG. 2, FIG. 2 is flow chart of the mesh processing method provided by the embodiment of the present disclosure. The mesh processing method comprises:

101: randomly selecting at least two triangular patches from a plurality of triangular patches of a triangular mesh as reference triangular patches.

In the embodiment of the present disclosure, the triangular mesh is constructed based on the point cloud data corresponding to a three-dimensional subject model, wherein the algorithm for constructing the triangular mesh based on the point cloud may comprise an Advancing Front Method, a Quadtree/Octree method, or a method based on Delaunay criterion.

The triangular mesh comprises a plurality of triangular patches. By randomly selecting multiple triangular patches as reference triangular patches, the selected reference triangular patches are random, which reduces the complexity of mesh processing.

102: dividing the triangular mesh into a plurality of sub-triangular meshes according to the spatial position of each of the reference triangular patches in the triangular mesh.

The respective spatial positions of the reference triangular patches in the triangular mesh are different. The triangular mesh is divided into a plurality of sub-triangular meshes according to the different spatial positions, so that the sub-triangular meshes can be traversed separately at the same time, thereby enhancing the traversal speed.

When the triangular mesh is divided according to the positions of the reference triangular patches, there is no intersecting triangular patch between the divided sub-triangular meshes. That is, each triangular patches is only included in one sub-triangular mesh, wherein, the triangular patches corresponding to respective sub-triangular meshes do not intersect with each other, so that the sub-triangular meshes can be traversed separately, thereby ensuring the orderly traversing over the respective sub-triangular meshes and enhancing the overall traversal speed of the triangular mesh.

Each sub-triangular mesh corresponds to one reference triangular patch contained in the sub-triangular mesh.

103: for each of the sub-triangular meshes, taking the reference triangular patch corresponding to the sub-triangular mesh as a traversal starting point and traversing the remaining triangular patches in the sub-triangular mesh.

For each sub-triangular mesh, the remaining triangular patches in the sub-triangular mesh are traversed by taking the reference triangular patch corresponding to the sub-triangular mesh as the traversal starting point, thereby achieving the traversing of the respective sub-triangular meshes separately at the same time. By converting the traversing of the entire triangular mesh into the simultaneous traversing of the of sub-triangular meshes, the traversal speed of the mesh is enhanced.

In the embodiment of the present disclosure, a spiral traversal order can be utilized to traverse the triangular patches in the respective sub-triangular meshes at the same time, wherein the spiral traversal order can be adjusted according to actual traversal requirements.

When the traversal speed of the triangular patches in the mesh is enhanced, the topological information corresponding to the respective triangular patches can be traversed and compressed respectively based on the traversal order, thereby enhancing the speed of the topological compression of the entire triangular mesh. Optionally, the method also comprises:
during the traversing, establishing an index for each of the reference triangular patches and obtaining a topological relation operator corresponding to each triangular patch;
for each sub-triangular mesh, concatenating multiple topological relation operators corresponding to the sub-triangular mesh according to the traversal order corresponding to the sub-triangular mesh to obtain a sub-operator string;
according to the index of the reference triangular patch corresponding to each of the sub-triangular meshes, splicing the sub-operator strings to obtain a general operator string;
encoding and compressing the general operator string according to the appearance frequency of each topological relation operator in the general operator string to obtain a compressed general operator string.

The index indicates the reference triangular patch correspondingly, and the corresponding triangular patch can be quickly found through the index. topological relation operator corresponding to each triangular patch

The topological relation operator corresponding to each triangular patch is used to indicate the topological relation between the triangular patch and the other triangular patches, wherein each topological relation operator corresponds to one topological relation. The topological relations are used to reflect the connections between the triangular patches.

For each sub-triangular mesh, after the topological relation operators of the respective triangular patches are concatenated according to the traversal order, the sub-operator string corresponding to the sub-triangular mesh can be obtained.

After the sub-operator strings corresponding to the respective sub-triangular meshes are concatenated according to the index, the general operator string corresponding to the entire triangular mesh can be obtained. The function of the index is to clarify the splicing order corresponding to the respective sub-operator strings, so as to obtain the ordered general operator string.

Since each topological relation operator corresponds to the topological information of one triangle patch, the general operator string corresponds to the topological information of the entire triangular mesh, and the topological information reflected by the general operator string is based on the traversal order of the triangle patches. Therefore, after the general operator string is compressed, the compression on the topological information of the triangular mesh can be accomplished, that is, the topological compression of the triangular mesh can be accomplished.

Through compressing the general operator string by the appearance frequency of each topological relation operator, the compression rate of the entire general operator string can be maximized, that is, the topological compression rate is enhanced.

In the application embodiment, the topological relation operator corresponding to each triangular patch can be determined according to the topological relation between this triangular patch and the other triangular patches in the sub-triangular mesh. Optionally, the step “obtaining a topological relation operator corresponding to each triangular patch” comprises:
for each triangular patch in each of the sub-triangular meshes, determining the topological relation between the triangular patch and multiple triangular patches that are not traversed in the sub-triangular mesh;
obtaining the topological relation operator corresponding to the triangular patch according to the topological relation.

The traversing process can be understood as the process of sequentially extracting each triangular patch from the sub-triangular mesh, wherein, for the extraction of each triangular patch, when the triangular patch is extracted, the topological information of the triangular patch is obtained according to the topological relation between the triangular patch and the other triangular patches in the sub-triangular mesh.

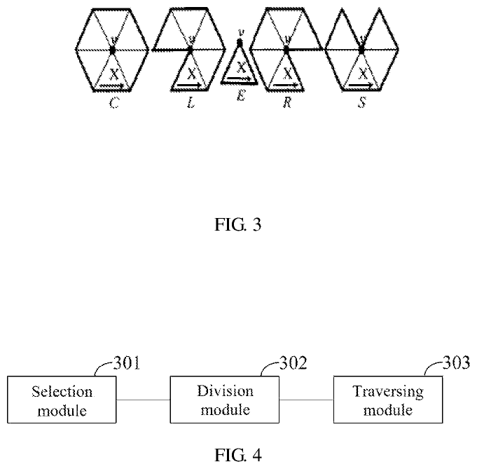

Please refer to FIG. 3, FIG. 3 is a schematic diagram showing the topological relation between the triangular patches provided by the embodiment of the application. For each triangular patch, the topological relation of the triangular patch in the current mesh is determined according to the connection relation between the triangular patch and the other triangular patches. For example, it is assumed that the current vertex ring is L (marked with a thick line), the entry on the ring is g, the triangular patch being accessed (or traversed or fetched) is X, and the third vertex of the triangular patch is v. For the triangular patch X, the connection relation between the triangular patch X and the other triangular patches includes the five cases shown in FIG. 3, and, accordingly, there are five cases for the topological relation of the triangular patch.

In the process of traversing the triangular patches in the respective sub-triangular meshes, for a different triangular patch, the topological relation between the triangular patch and the other triangular patches can be obtained according to the connection relation between the triangular patch and the other triangular patches.

In the embodiment of the present disclosure, each topological relation can be represented by a corresponding topological relation operator, that is, for each topological relation, a corresponding topological relation operator can be defined For example, please refer to FIG. 3, the five cases correspond to the topological relation operators respectively.

If v is a vertex that has not been traversed, then the topological relation operator corresponding to the topological relation of the triangular patch X is C.

If v is a front vertex of the entry on the vertex ring, then the topological relation operator corresponding to the topological relation of the triangular patch X is L.

If there are only three vertices on the vertex ring and further the three vertices of the triangular patch X being accessed, then the topological relation operator corresponding to the topological relation of the triangular patch X is E.

If v is a rear vertex on the vertex ring, then the topological relation operator corresponding to the topological relation of the triangular patch X is R.

If v is a vertex at another position on the vertex ring, then the topological relation operator corresponding to the topological relation of the triangular patch X is S.

In the embodiment of the present disclosure, the topological relation operator corresponding to each topological relation can be replaced by the operation code in the Edgebreaker compression algorithm.

As the above description related to the topological relation operators corresponding to the above topological relations, the topological relation operators corresponding to the respective topological relations can be stored in the mapping relation set. The topological relation operator corresponding to the topological relation of each triangular patch can be obtained according to the mapping relation set. That is, optionally, in some embodiments of the present disclosure, the step “obtaining the topological relation operator corresponding to the triangular patch according to the topological relation” comprises:
obtaining a mapping relation set, the mapping relation set comprising a mapping relation between a preset topological relation and a preset topological relation operator;
determining the topological relation operator corresponding to the topological relation of the triangular patch according to the mapping relation.

By storing the corresponding relation between the topological relation and the topological relation operator in the mapping relation set, the topological relation operator corresponding to the topological relation can be obtained quickly from the mapping relation set after the topological relationship of each triangular patch is obtained. Thus, the topological relation operator corresponding to each triangular patch is obtained quickly, thereby enhancing the topological compression speed of the triangular mesh.

In the embodiment of the present disclosure, when the compression is performed on the general operator string, a Huffman tree can be constructed according to the appearance frequency of each topological relation operator. The general operator string can be encoded and compressed with Huffman encoding. Optionally, the step “encoding and compressing the general operator string according to the appearance frequency of each topological relation operator in the general operator string to obtain a compressed general operator string” comprises:

encoding and compressing the general string with Huffman coding to obtain the compressed general operator string.

The Huffman coding, which is sometimes called as the optimal coding, and is generally called as Huffman coding, constructs the codeword with the shortest average length of different prefixes according to the appearance probability of the characters. The general operator string is compressed with Huffman coding. The general operator string after compression can be minimized as much as possible, thereby enhancing the compression ratio of the general operator string.

In the embodiment of the present disclosure, after topological compression is performed on the topology information of the triangular mesh, the compression of the triangular mesh can be completed according to the topological compression. Optionally, the triangular patch comprises three vertices of the triangular mesh. After the step “encoding and compressing the general operator string according to the appearance frequency of each topological relation operator in the general operator string to obtain a compressed general operator string”, the method further comprises:
according to the traversal order corresponding to the respective sub-triangular meshes and the corresponding index of each sub-triangular mesh, compressing the respective sub-triangular meshes at the same time to obtain a preliminary compressed file;
integrating the indexes and the compressed general operator string integrated into the preliminary compressed file to obtain a general compressed file corresponding to the triangular mesh.

Compared to the related technology that compresses a triangular mesh based on traversing of a single triangular patch, the compression speed of the triangular mesh can be enhanced by performing the topological compression on the respective sub-triangular meshes at the same time.

In the embodiment of the present disclosure, by integrating the index corresponding to each sub-triangular mesh and the topological compression result into the compressed file of the triangular mesh, the sub-triangular meshes corresponding to the respective indexes can be decompressed at the same time when the compressed file is decompressed, thereby enhancing the decompression efficiency of the triangular mesh. Optionally, the method also comprises:
when the general compressed file is decompressed, decompressing the compressed general operator string to obtain the general operator string, and, at the same time, decompressing the sub-triangular mesh corresponding to each index to obtain multiple triangular patches corresponding each of the sub-triangular meshes;
according to the respective topological relations of the respective triangular patches described by the general operator string, splicing the triangular patches corresponding to each of the sub-triangular meshes to obtain the triangular mesh.

By extracting the indexes from the compressed file, the sub-triangular mesh corresponding to each index can be determined. Therefore, when the compressed file is decompressed, the sub-triangular meshes corresponding to the respective indexes can be decompressed at the same time, thereby enhancing the decompression efficiency of the triangular mesh.

After the compressed file is decompressed, the triangular regions corresponding to the respective triangular patches can be obtained. Then, through the topological relations between the respective triangular patches recorded in the general operator string, the respective triangular regions can be spliced together in the order reverse to the traversal order, and then the triangular mesh corresponding to the compressed file is obtained through the decompression.

Embodiments of the present disclosure randomly select at least two triangular patches from a plurality of triangular patches of a triangular mesh as reference triangular patches, divides the triangular mesh into a plurality of sub-triangular meshes according to a spatial position of each of the reference triangular patches in the triangular mesh, and for each of the sub-triangular meshes, take the reference triangular patch corresponding to the sub-triangular mesh as a traversal starting point and traversing the remaining triangular patches in the sub-triangular mesh. Compared to the related technology that selects a single triangular patch to be traversed from a triangular mesh, the traversal speed of the triangular patches can be enhanced by selecting multiple triangular patches, taking the respective reference triangular patches as traversal starting points, and traversing the triangular patches in the triangular mesh at the same time. The remaining triangular patches in each sub-triangular mesh can be traversing at the same time by dividing the triangular mesh into the sub-triangular meshes according to the spatial position of each of the reference triangular patches in the triangular mesh, which avoids the traversal repetition during a plurality of traversing processes and ensures the orderly execution of the respective traversing processes. In the embodiment of the present disclosure, when the respective sub-triangular meshes is traversed, compressed, or decompressed at the same time, the corresponding processing efficiency can be enhanced based on the advantages of multi-core processing of a terminal device.

The present disclosure also provides a mesh processing device based on the above mesh processing method. The meaning of the term “the third target” is the same as that in the above-mentioned mesh processing method. For details of implement, please refer to the description in the method embodiment.

Please refer to FIG. 4 illustrating a schematic diagram showing a method processing device of an embodiment of the present disclosure, and the mesh processing device 300 comprises a selection module 301, a division module 302, and a traversing module 303.

The selection module 301 is configured to randomly select at least two triangular patches from a plurality of triangular patches of a triangular mesh as reference triangular patches.

The dividing module 302 is configured to divide the triangular mesh into a plurality of sub-triangular meshes according to the spatial position of each of the reference triangular patches in the triangular mesh.

The traversal module 303 is configured to, for each of the sub-triangular meshes, take the reference triangular patch corresponding to the sub-triangular mesh as a traversal starting point and traverse the remaining triangular patches in the sub-triangular mesh.

The device also comprises a topological compression module. The topological compression module comprises:
an acquisition unit configured to, in the traversing process, establish an index of each of the reference triangular patches and obtain a topological relation operator corresponding to each triangular patch;
a concatenation unit configured to, for each sub-triangular mesh, concatenate multiple topological relation operators corresponding to the sub-triangular mesh according to the traversal order corresponding to the sub-triangular mesh to obtain a sub-operator string;
a splicing unit configured to, according to the index of the reference triangular patch corresponding to each of the sub-triangular meshes, splice the sub-operator strings to obtain a general operator string;
a topological compression unit configured to encode and compress the general operator string according to the appearance frequency of each topological relation operator in the general operator string to obtain a compressed general operator string.

The acquisition unit comprises:
a determination subunit configured to, for each triangular patch in each of the sub-triangular meshes, determine the topological relation between the triangular patch and multiple triangular patches that are not traversed in the sub-triangular mesh;
an acquisition subunit configured to obtain the topological relation operator corresponding to the triangular patch according to the topological relation.

The acquisition subunit is configured to:
obtain a mapping relation set, the mapping relation set comprising a mapping relation between a preset topological relation and a preset topological relation operator;
determine the topological relation operator corresponding to the topological relation of the triangular patch according to the mapping relation.

The topological compression unit comprises a topological compression subunit that is configured to encoding and compressing the general operator string with Huffman coding to obtain the compressed general operator string.

The triangular patch comprises three vertices of the triangular mesh. The device further comprises a mesh compression module, and the mesh compression module comprises:
a preliminary compression unit configured to compress the respective sub-triangular meshes at the same time according to the traversal order corresponding to the respective sub-triangular meshes and the corresponding index of each sub-triangular mesh to obtain a preliminary compressed file;
an integration unit configured to integrate the indexes and the compressed general operator string integrated into the preliminary compressed file to obtain a general compressed file corresponding to the triangular mesh.

The device further comprises a decompression module, and the decompression module comprises:
a decompression unit configured to, when the general compressed file is decompressed, decompress the compressed general operator string to obtain the general operator string, and, at the same time, decompress the sub-triangular mesh corresponding to each index to obtain multiple triangular patches corresponding each of the sub-triangular meshes;
a connection unit configured to splice the triangular patches corresponding to each of the sub-triangular meshes according to the respective topological relations of the respective triangular patches described by the general operator string to obtain the triangular mesh.

In the embodiment of the present disclosure, the selection module 301 randomly selects at least two triangular patches from a plurality of triangular patches of a triangular mesh as reference triangular patches, and then the division module 302 divides the triangular mesh into a plurality of sub-triangular meshes according to the spatial position of each of the reference triangular patches in the triangular mesh. For each of the sub-triangular meshes, the traversal module 303 takes the reference triangular patch corresponding to the sub-triangular mesh as a traversal starting point and traverses the remaining triangular patches in the sub-triangular mesh.

The embodiments of the present disclosure randomly select at least two triangular patches from a plurality of triangular patches of a triangular mesh as reference triangular patches, divides the triangular mesh into a plurality of sub-triangular meshes according to a spatial position of each of the reference triangular patches in the triangular mesh, and for each of the sub-triangular meshes, take the reference triangular patch corresponding to the sub-triangular mesh as a traversal starting point and traversing the remaining triangular patches in the sub-triangular mesh. Compared to the related technology that selects a single triangular patch to be traversed from a triangular mesh, the traversal speed of the triangular patches can be enhanced by selecting multiple triangular patches, taking the respective reference triangular patches as traversal starting points, and traversing the triangular patches in the triangular mesh at the same time. The remaining triangular patches in each sub-triangular mesh can be traversing at the same time by dividing the triangular mesh into the sub-triangular meshes according to the spatial position of each of the reference triangular patches in the triangular mesh, which avoids the traversal repetition during a plurality of traversing processes and ensures the orderly execution of the respective traversing processes.

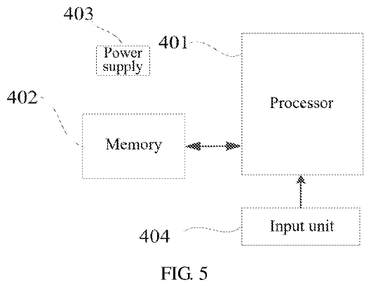

In addition, the present disclosure also provides an electronic apparatus, as shown in FIG. 5, which shows a schematic diagram showing an electronic apparatus involved in the present disclosure.

The electronic apparatus may comprise a processor 401 with one or more processing cores, a memory 402 with one or more computer-readable storage medium, a power supply 403, an input unit 404 and other components. The structure of the electronic apparatus shown in FIG. 5 does not be provided to limit the electronic apparatus and may comprise more or less components than those shown in the drawings, or combine some components, or provide a different arrangement of the components.

The processor 401 is the control center of the electronic device, and uses various interfaces and lines to connect various parts of the entire electronic device, by running or executing software programs and/or modules stored in the memory 402, and calling the Data, perform various functions of electronic devices and process data. Optionally, the processor 401 may include one or more processing cores. Preferably, the processor 401 can integrate an application processor and a modem processor. The application processor mainly deals with the operating system, object interface and application programs, etc., and the modem processor mainly deals with wireless communication. The above modem processor may not be integrated into the processor 401.

The memory 402 can be used to store software programs and modules, and the processor 401 executes various functional applications and data processing by running the software programs and modules stored in the memory 402. The memory 402 may mainly include an area for storing programs and an area for storing data. The stored program area can store an operating system, an application program required by at least one function (such as a sound playing function, an image playing function, etc.), and the like. The storage data area may store data and the like created according to use of the electronic device. In addition, the memory 402 may include a high-speed random access memory, and may also include a non-volatile memory, such as at least one magnetic disk storage device, flash memory device, or other volatile solid-state storage devices. Correspondingly, the memory 402 may further include a memory controller to provide the processor 401 with access to the memory 402.

The electronic device also includes a power supply 403 for supplying power to various components. Preferably, the power supply 403 can be logically connected to the processor 401 through a power management system, so as to implement functions such as management of charging, discharging, and power consumption management through the power management system. The power supply 403 may also include one or more DC or AC power supplies, recharging systems, power failure detection circuits, power converters or inverters, power status indicators and other arbitrary components.

The electronic apparatus can also include an input unit 404, which can be used to receive input numbers or character information, and generate input of object setting and function control related to a keyboard, a mouse, a joystick, an optical trackball.

The electronic device may also include a display unit, not shown in figures, which will not be repeated here. The processor 401 in the electronic apparatus loads an executable file corresponding to the process of one or more application programs into the memory 402 according to the following instructions, and the processor 401 executes the application(s) stored in the memory 402, thereby implementing the steps in any of the mesh processing methods provided in the present disclosure.

The embodiments of the present disclosure randomly select at least two triangular patches from a plurality of triangular patches of a triangular mesh as reference triangular patches, divides the triangular mesh into a plurality of sub-triangular meshes according to a spatial position of each of the reference triangular patches in the triangular mesh, and for each of the sub-triangular meshes, take the reference triangular patch corresponding to the sub-triangular mesh as a traversal starting point and traversing the remaining triangular patches in the sub-triangular mesh. Compared to the related technology that selects a single triangular patch to be traversed from a triangular mesh, the traversal speed of the triangular patches can be enhanced by selecting multiple triangular patches, taking the respective reference triangular patches as traversal starting points, and traversing the triangular patches in the triangular mesh at the same time. The remaining triangular patches in each sub-triangular mesh can be traversing at the same time by dividing the triangular mesh into the sub-triangular meshes according to the spatial position of each of the reference triangular patches in the triangular mesh, which avoids the traversal repetition during a plurality of traversing processes and ensures the orderly execution of the respective traversing processes.

The present disclosure provides a non-transitory computer-readable storage medium. The non-transitory computer-readable storage medium stores computer instructions. The computer program can be loaded by a processor to perform the steps in any mesh processing method provided by the present disclosure.

The non-transitory computer-readable storage medium may include: a read only memory (ROM), a random access memory (RAM), a magnetic disk or an optical disk, and the like.

Since the instructions stored in the computer-readable storage medium can be used to perform the steps in any mesh processing method provided in the present disclosure. Thus, the beneficial effects that can be achieved by any mesh processing method provided in the present. Please refer to the previous embodiments for details, and the related description is not repeated.

While the embodiments of the present disclosure have been shown and described above, it is to be understood that the above embodiments are exemplary and are not to be construed as limiting the present disclosure. One of ordinary skill in the art may make variations, modifications, substitutions and alterations to the above embodiments within the scope of the present disclosure.

What is claimed is:

1. A mesh processing method comprising:
randomly selecting at least two triangular patches from a plurality of triangular patches of a triangular mesh as reference triangular patches;
dividing the triangular mesh into a plurality of sub-triangular meshes according to a spatial position of each of the reference triangular patches in the triangular mesh;
for each of the sub-triangular meshes, taking the reference triangular patch corresponding to the sub-triangular mesh as a traversal starting point and traversing the remaining triangular patches in the sub-triangular mesh.

2. The method of claim 1, further comprising:
during the traversing, establishing an index for each of the reference triangular patches and obtaining a topological relation operator corresponding to each triangular patch;
for each sub-triangular mesh, concatenating multiple topological relation operators corresponding to the sub-triangular mesh according to a traversal order corresponding to the sub-triangular mesh to obtain a sub-operator string;
according to the index of the reference triangular patch corresponding to each of the sub-triangular meshes, splicing the sub-operator strings to obtain a general operator string;
encoding and compressing the general operator string according to an appearance frequency of each topological relation operator in the general operator string to obtain a compressed general operator string.

3. The method according to claim 2, wherein obtaining a topological relation operator corresponding to each triangular patch comprises:
for each triangular patch in each of the sub-triangular meshes, determining a topological relation between the triangular patch and multiple triangular patches that are not traversed in the sub-triangular mesh;
obtaining the topological relation operator corresponding to the triangular patch according to the topological relation.

4. The method according to claim 3, wherein the obtaining the topological relation operator corresponding to the triangular patch according to the topological relation comprises:
obtaining a mapping relation set, the mapping relation set comprising a mapping relation between a preset topological relation and a preset topological relation operator;
determining the topological relation operator corresponding to the topological relation of the triangular patch according to the mapping relation.

5. The method according to claim 2, wherein the encoding and compressing the general operator string according to an appearance frequency of each topological relation operator in the general operator string to obtain a compressed general operator string comprises:
encoding and compressing the general operator string with Huffman coding to obtain the compressed general operator string.

6. The method of claim 2, wherein the triangular patch comprises three vertices of the triangular mesh, and after the encoding and compressing the general operator string according to an appearance frequency of each topological relation operator in the general operator string to obtain a compressed general operator string, the method further comprises:
according to the traversal order corresponding to the respective sub-triangular meshes and the corresponding index of each sub-triangular mesh, compressing the respective sub-triangular meshes at the same time to obtain a preliminary compressed file;
integrating the indexes and the compressed general operator string integrated into the preliminary compressed file to obtain a general compressed file corresponding to the triangular mesh.

7. The method of claim 6, further comprising:
when the general compressed file is decompressed, decompressing the compressed general operator string to obtain the general operator string, and, at the same time, decompressing the sub-triangular mesh corresponding to each index to obtain multiple triangular patches corresponding each of the sub-triangular meshes;
according to topological relations of the respective triangular patches described by the general operator string, splicing the triangular patches corresponding to each of the sub-triangular meshes to obtain the triangular mesh.

8. An electronics apparatus comprising:
a processor;
a memory, storing computer instructions executable by the processor to perform operations comprising:
randomly selecting at least two triangular patches from a plurality of triangular patches of a triangular mesh as reference triangular patches;
dividing the triangular mesh into a plurality of sub-triangular meshes according to a spatial position of each of the reference triangular patches in the triangular mesh;
for each of the sub-triangular meshes, taking the reference triangular patch corresponding to the sub-triangular mesh as a traversal starting point and traversing the remaining triangular patches in the sub-triangular mesh.

9. The electronics apparatus of claim 8, wherein the operations further comprise:
during the traversing, establishing an index for each of the reference triangular patches and obtaining a topological relation operator corresponding to each triangular patch;
for each sub-triangular mesh, concatenating multiple topological relation operators corresponding to the sub-triangular mesh according to a traversal order corresponding to the sub-triangular mesh to obtain a sub-operator string;
according to the index of the reference triangular patch corresponding to each of the sub-triangular meshes, splicing the sub-operator strings to obtain a general operator string;
encoding and compressing the general operator string according to an appearance frequency of each topological relation operator in the general operator string to obtain a compressed general operator string.

10. The electronics apparatus according to claim 9, wherein obtaining a topological relation operator corresponding to each triangular patch comprises:
for each triangular patch in each of the sub-triangular meshes, determining a topological relation between the triangular patch and multiple triangular patches that are not traversed in the sub-triangular mesh;
obtaining the topological relation operator corresponding to the triangular patch according to the topological relation.

11. The electronics apparatus according to claim 10, wherein the obtaining the topological relation operator corresponding to the triangular patch according to the topological relation comprises:
obtaining a mapping relation set, the mapping relation set comprising a mapping relation between a preset topological relation and a preset topological relation operator;
determining the topological relation operator corresponding to the topological relation of the triangular patch according to the mapping relation.

12. The electronics apparatus according to claim 9, wherein the encoding and compressing the general operator string according to an appearance frequency of each topological relation operator in the general operator string to obtain a compressed general operator string comprises:
encoding and compressing the general operator string with Huffman coding to obtain the compressed general operator string.

13. The electronics apparatus of claim 9, wherein the triangular patch comprises three vertices of the triangular mesh, and after the encoding and compressing the general operator string according to an appearance frequency of each topological relation operator in the general operator string to obtain a compressed general operator string, the method further comprises:
according to the traversal order corresponding to the respective sub-triangular meshes and the corresponding index of each sub-triangular mesh, compressing the respective sub-triangular meshes at the same time to obtain a preliminary compressed file;
integrating the indexes and the compressed general operator string integrated into the preliminary compressed file to obtain a general compressed file corresponding to the triangular mesh.

14. The electronics apparatus of claim 13, the operations further comprise:
when the general compressed file is decompressed, decompressing the compressed general operator string to obtain the general operator string, and, at the same time, decompressing the sub-triangular mesh corresponding to each index to obtain multiple triangular patches corresponding each of the sub-triangular meshes;
according to topological relations of the respective triangular patches described by the general operator string, splicing the triangular patches corresponding to each of the sub-triangular meshes to obtain the triangular mesh.

15. A non-transitory computer readable storage medium, storing computer instructions executable by a processor to perform operations comprising:
randomly selecting at least two triangular patches from a plurality of triangular patches of a triangular mesh as reference triangular patches;
dividing the triangular mesh into a plurality of sub-triangular meshes according to a spatial position of each of the reference triangular patches in the triangular mesh;
for each of the sub-triangular meshes, taking the reference triangular patch corresponding to the sub-triangular mesh as a traversal starting point and traversing the remaining triangular patches in the sub-triangular mesh.

16. The electronics apparatus of claim 15, wherein the operations further comprise:
during the traversing, establishing an index for each of the reference triangular patches and obtaining a topological relation operator corresponding to each triangular patch;
for each sub-triangular mesh, concatenating multiple topological relation operators corresponding to the sub-triangular mesh according to a traversal order corresponding to the sub-triangular mesh to obtain a sub-operator string;
according to the index of the reference triangular patch corresponding to each of the sub-triangular meshes, splicing the sub-operator strings to obtain a general operator string;
encoding and compressing the general operator string according to an appearance frequency of each topological relation operator in the general operator string to obtain a compressed general operator string.

17. The non-transitory computer readable storage medium according to claim 16, wherein obtaining a topological relation operator corresponding to each triangular patch comprises:
for each triangular patch in each of the sub-triangular meshes, determining a topological relation between the triangular patch and multiple triangular patches that are not traversed in the sub-triangular mesh;
obtaining the topological relation operator corresponding to the triangular patch according to the topological relation.

18. The non-transitory computer readable storage medium according to claim 17, wherein the obtaining the topological relation operator corresponding to the triangular patch according to the topological relation comprises:
obtaining a mapping relation set, the mapping relation set comprising a mapping relation between a preset topological relation and a preset topological relation operator;
determining the topological relation operator corresponding to the topological relation of the triangular patch according to the mapping relation.

19. The non-transitory computer readable storage medium according to claim 16, wherein the encoding and compressing the general operator string according to an appearance frequency of each topological relation operator in the general operator string to obtain a compressed general operator string comprises:
encoding and compressing the general operator string with Huffman coding to obtain the compressed general operator string.

20. The non-transitory computer readable storage medium of claim 16, wherein the triangular patch comprises three vertices of the triangular mesh, and after the encoding and compressing the general operator string according to an appearance frequency of each topological relation operator in the general operator string to obtain a compressed general operator string, the method further comprises:
according to the traversal order corresponding to the respective sub-triangular meshes and the corresponding index of each sub-triangular mesh, compressing the respective sub-triangular meshes at the same time to obtain a preliminary compressed file;
integrating the indexes and the compressed general operator string integrated into the preliminary compressed file to obtain a general compressed file corresponding to the triangular mesh.
